(19) United States
(12) Patent Application Publication
(10) Pub. No.: US 2025/0210335 A1
(43) Pub. Date: Jun. 26, 2025

(54) MASS RECALIBRATION FOR MASS SPECTROMETRY DATA

(71) Applicant: Bruker Daltonics GmbH & Co. KG, Bremen (DE)

(72) Inventors: Tobias BOSKAMP, Worpswede (DE); Alexander DENKER, Edewecht (DE)

(21) Appl. No.: 18/990,022

(22) Filed: Dec. 20, 2024

Related U.S. Application Data
(60) Provisional application No. 63/613,939, filed on Dec. 22, 2023.

(51) Int. Cl. H01J 49/00; H01J 49/16

(52) U.S. Cl. CPC H01J 49/0036; H01J 49/0009; H01J 49/164

(57) ABSTRACT

The disclosure relates to producing and using a machine-learned or trained algorithm, such as resulting from (supervised) training a multi-layered or convolutional neural network using mass-curated training spectra, for mass recalibration of mass spectrometry data, in particular applied to mass spectrometry data which are based on matrix-assisted laser desorption/ionization (MALDI) as ionization mechanism, further in particular applied to mass spectrometry imaging (MSI) data, and further in particular including subjecting the mass spectrometry data to mass defect analysis, such as Kendrick mass defect analysis. In so doing, the quality of mass spectrometry data can be improved in a timely manner.

### BACKGROUND OF THE INVENTION

### Field of the Invention

The disclosure relates to producing and using a machine-learned or trained algorithm, such as resulting from (supervised) training a multi-layered or convolutional neural network using mass-curated training spectra, for mass recalibration of mass spectrometry data, in particular applied to mass spectrometry data which are based on matrix-assisted laser desorption/ionization (MALDI) as ionization mechanism, further in particular applied to mass spectrometry imaging (MSI) data, and further in particular including subjecting the mass spectrometry data to mass defect analysis, such as Kendrick mass defect analysis. In so doing, the quality of mass spectrometry data can be improved in a timely manner.

### Description of the Related Art

The prior art is explained below with reference to a specific aspect. However, this should not be understood as a limitation. Useful further developments and modifications of what is known from the prior art may also be applicable beyond the comparatively narrow scope of this introduction and will be readily apparent to skilled practitioners in this field after reading the disclosure following the introduction.

Mass spectrometry imaging is a technique that allows the visualization of the spatial distribution of molecules on a surface, such as a biological tissue section, by measuring their mass-to-charge ratios m/z. MSI can detect a wide range of molecules, such as metabolites, peptides, proteins, lipids, or drugs, without the need for labeling or extraction, and provide valuable information about the molecular composition, structure, and function of cells and tissues, as well as their changes in response to diseases or treatments.

MSI works by scanning the sample with a focused ionization beam, such as a laser or an ion beam, and recording the mass spectrum at each spot. The mass spectrum contains the signals of the molecules that are desorbed and ionized from the sample spot by the beam. By selecting a specific signal that corresponds to a molecule of interest, the intensity of that signal can be mapped across the sample, creating an image that shows the spatial distribution of that molecule. MSI can generate multiple images for different molecules from the same sample, as each mass spectrum contains many signals.

There are different types of ionization techniques that can be used for MSI, such as matrix-assisted laser desorption/ionization, secondary ion mass spectrometry (SIMS), desorption electrospray ionization (DESI), or laser ablation electrospray ionization (LAESI). Each technique has its own advantages and limitations, depending on the type of sample, the size of molecules, the spatial resolution, the sensitivity, and the specificity. MSI also requires careful sample preparation, data acquisition, and data analysis to ensure the quality and reliability of the results.

MSI has many applications in various fields, such as biology, medicine, pharmacology, food, and environmental sciences, and can reveal the molecular heterogeneity, complexity, and dynamics of biological systems, as well as the interactions and functions of different molecules. MSI can also help to identify biomarkers, diagnose diseases, monitor drug delivery and metabolism, and evaluate treatment effects.

The mass accuracy in mass spectrometry data, in particular MALDI MSI data, may depend on many different factors, including the sample type, the type of mass analyzer instrument, as well as the preparation and acquisition protocols. A low mass accuracy may make it difficult or even impossible to analyze the mass spectrometry data and to correctly interpret the outcome of an experiment. Thus, achieving a high mass accuracy is a prerequisite for many applications of mass spectrometry, and in particular MALDI MSI.

Several methods exist to perform a recalibration of mass spectrometry data, including methods based on the detection of specific calibrant peaks and comparing the measured masses to the a-priori known theoretical masses. Such methods may fail in cases where a calibrant peak cannot be detected, due to, for example, low signal-to-noise in a spectrum, or to an inhomogeneous spatial distribution of the calibrant.

Moreover, adding calibrants to a sample under investigation, such as a tissue sample for MALDI MSI, may have an impact on the ionization of analyte molecules from the sample, thus changing the outcome of the experiment. There are other methods that do not depend on calibrant peak detection, but also these methods are only applicable under certain preconditions, or they require a high computational effort.

In the following, documents of the prior art which may be related to the present disclosure will be briefly cited, without claiming completeness:

The study by Assaf Wool et al. (Proteomics 2002, 2, 1365-1373) deals with a precalibration of matrix-assisted laser desorption/ionization-time of flight spectra for peptide mass fingerprinting.

The patent publication US 2018/0019110 A1 pertains to a mass spectrometry data analysis method for analyzing a specimen having a composition with two different reference chemical structures A and B that are each repeated. Included is acquiring exact mass information of each peak in a mass spectrum of the specimen by mass spectrometry, acquiring Kendrick mass defect information D_{A} and D_{B} where a decimal number part has been extracted from mass information obtained by performing Kendrick mass conversion computation processing on exact mass information of each peak, acquiring mass defect information d_{B} and d_{A} where a decimal number part has been extracted from mass information of B based on A and A based on B of the reference chemical structures A and B, calculating

$${n}_{A} = {D}_{B} / {d}_{A} , {n}_{B} = {D}_{A} / {d}_{B}$$

regarding D_{A}, D_{B}, d_{A}, and d_{B}, and obtaining degree-of-polymerization information n_{A} and n_{B}, and displaying plots corresponding to each peak on two-dimensional coordinates where n_{A} and n_{B} are axes.

The patent publication US 2019/0257839 A1, which is incorporated herein by reference in its entirety, relates to a method to evaluate mass spectrometry data for the analysis of peptides from biological samples, particularly MALDI-TOF mass spectrometry data, comprising the following steps: a) provide expected mass defects; b) determine measured mass defects, i.e., the mass defects resulting from the mass spectrometry data; c) compare the measured mass defects with the expected mass defects.

The patent publication US 2020/0328069 A1, which is incorporated herein by reference in its entirety, relates to a method which is suitable for the quality control and signal correction of mass spectrometry data of biological tissue samples and is based on the analysis of the chemical background signal observed in a spectrum. It exploits the fact that the chemical background signal contains components from a plurality of polymer molecules, whose chemical structure has strong regularities. These regularities mean that the observed masses are subject to certain statistical distributions, which are each characteristic of the class of molecule. By analyzing these statistical properties, it is possible to detect and correct any mass shifts which may be present.

The patent publication US 2021/0065849 A1 pertains to a preprocessor which extracts a plurality of spectra to be processed, from an overall mass spectrum. A simulated spectrum generator having a learned model generates a simulated spectrum having a peak discriminating action, from each mass spectrum. A postprocessor generates a combined simulated spectrum based on the plurality of simulated spectra. A peak filter executes peak discrimination on a peak list using the combined simulated spectrum.

In view of the foregoing, there is still a need for refined and improved mass recalibration of mass spectrometry data, in particular, using machine learning methods.

### BRIEF SUMMARY OF THE INVENTION

According to a first aspect, the disclosure relates to a method of mass spectrometry, comprising: —acquiring or providing a mass spectrum which encompasses a plurality of measured ionic abundance values, each measured ionic abundance value from the plurality of measured ionic abundance values being associated with a value or value range on a first mass-related scale; —applying an algorithm on the mass spectrum which includes a mapping of ionic abundance values to a second mass-related scale, the mapping encompassing at least one of (i) a confirming where the second mass-related scale substantially coincides with the first mass-related scale, and (ii) a revising where the second mass-related scale does not substantially coincide with the first mass-related scale; and—processing the mass spectrum to have a mass-related scale which is at least one of confirmed and revised; wherein the algorithm implements a result of training on a multitude of datasets using machine learning, wherein each dataset from the multitude of datasets contains and/or derives from a mass-curated training spectrum which is subjected to one or more deliberate mass-related scale modifications, and wherein the training aims at providing for the mapping to substantially undo or substantially compensate for the one or more deliberate mass-related scale modifications. In special embodiments, the training may aim at providing for the mapping to substantially undo or substantially compensate for any, each and every deliberate mass-related scale modification.

A mass spectrum may represent a structure of registering and storing relative abundance and masses of charged molecules or ions in the gas phase generated from a sample. Representations of a mass spectrum typically display a mass-related scale as the horizontal axis and an ionic abundance-related scale as the vertical axis. Within the ambit of the present disclosure, also peak lists, i.e., datasets of abundance-mass pairs which do not necessarily have a continuous and contiguous mass-related scale and in which noise is largely, if not completely, absent, are meant to be included in the definition of a mass spectrum.

In the context of the present disclosure, the term “mass-curated” as used in the term “mass-curated training spectrum” means that the training spectra are or have been mass-calibrated using methods having high level of accuracy and precision.

It is possible that the training of the machine learning model and/or the application of the algorithm, which implements a result of the machine learning, to the mass spectrum is executed accounting only for ionic manifestations on the mass-related scale, such as observing only signal peak positions along a mass-related scale, such as centroids, and substantially ignoring any actual ionic abundance or ionic intensity associated with each signal peak along such mass-related scale. It is further possible to use ionic abundance information as weighting factors in order to favor strong signal components over weak ones in the training and/or recalibration phases.

On applying the algorithm, which implements a result of the machine learning, the mass spectrum may be processed in a way that its complete mass-related scale is revised as compared to the first mass-related scale, for example, when each and every mass-related bin or mass-related range along the mass-related scale in the mass spectrum suffers from a mass-related inaccuracy which goes beyond a tolerance level, such as deviating equal to or more than X parts per million (ppm) where X may be taken from among the group including: 10, 9, 8, 7, 6, 5, 4, 3, 2, 1. It is likewise contemplated that the processing of the mass spectrum may lead to its mass-related scale being partly revised and being partly confirmed, the latter being applicable, for instance, when a mass-related inaccuracy determined in one or more mass-related bins or mass-related ranges along its mass-related scale stays within a tolerance level as defined above, by way of example. Finally, it is also possible that the processing of the mass spectrum may lead to its mass-related scale being confirmed along its full extension, for example, when all mass-related bins or all mass-related ranges along the mass-related scale do not suffer from any mass-related inaccuracy beyond a tolerance level, such as defined above, by way of example.

In various embodiments, the acquiring of a mass spectrum may be carried out using an analyzer working according to a principle taken from among the group including: time-of-flight analyzer, ion cyclotron resonance analyzer, analyzer of the Kingdon type, such as the Orbitrap®. A time-of-flight analyzer, in which ions may be accelerated axially or orthogonally, has the advantages of (i) high transmission efficiency, which means that it can detect most of the ions that enter the analyzer without losing them, resulting in higher sensitivity and lower detection limits, (ii) no upper m/z limit, which means that it can measure the mass of very large molecules, such as proteins or polymers, without breaking them into smaller fragments, allowing for the analysis of intact biomolecules and complex mixtures, (iii) fast scan rates, which means that it can acquire a full mass spectrum in a very short time, usually in microseconds, enabling the analysis of transient or dynamic phenomena, such as chemical reactions or biological processes, and (iv) compatibility with various ion sources, such as electron ionization (EI), chemical ionization (CI), matrix-assisted laser desorption/ionization (MALDI), electrospray ionization (ESI), and techniques, such as ion mobility spectrometry (IMS), and collision-induced dissociation (CID), providing versatility and flexibility for different applications and domains.

In various embodiments, the mass-related scale may comprise one of a mass scale, m, and a mass to charge ratio scale, m/z. Working with the mass to charge ratio m/z instead of the mass m dispenses with the need to deduce or ascertain a charge state for each signal peak in the mass spectrometry data, which may introduce uncertainty and may further be a computationally lengthy process, in particular, when the number of such signal peaks is large. Certain ionization mechanisms are known to produce predominantly ions having single charge, such as MALDI, which simplifies further data handling with respect to the mass-related scale.

In various embodiments, the machine learning may include a method taken from among the group including: multi-layered machine learning, supervised machine learning, deep learning, neural network, such as convolutional neural network. Preferably, a neural network may have an architecture which comprises an initial block including a plurality of convolutional layers, followed by a second block including a plurality of fully connected layers. Such design of a neural network facilitates (i) processing of high-dimensional inputs, such as images, more efficiently and effectively, as convolutional layers reduce the number of parameters and weights by applying filters to local regions of the input, (ii) the ability to learn hierarchical and spatial features from the input, as convolutional layers capture local patterns and pooling layers aggregate them into higher-level features, (iii) the avoidance of dying neurons, as convolutional layers use activation functions like ReLU or LeakyReLU, which allow a small gradient for negative inputs, unlike fully connected layers that use sigmoid or tanh functions, which can saturate and kill the gradient, and (iv) higher accuracy and performance in tasks like image classification, object detection, and segmentation, as convolutional layers can assign importance to different features and fully connected layers can learn non-linear combinations of them.

In various embodiments, the first mass-related scale may be pre-mass-calibrated using raw mass spectrometry data and applying thereon a method taken from among the group including: internal lockmass calibrants, external lockmass calibrants, statistical evaluation of molecular content. The principle of internal lockmass calibration generally is to select a signal peak of known identity and mass-to-charge ratio (m/z) that is present in the mass spectrometry data. In MALDI samples, this may encompass one or more signal peaks resulting or deriving from the MALDI matrix substance, such as a-Cyano-4-hydroxycinnamic acid (CHCA). This peak is called the “lockmass” and is used to map the proxy parameter observed during an acquisition, such as the time of flight, on a mass-related scale. The principle of external lockmass calibration is to introduce a small amount of a calibrant compound into the ion source along with any analyte compound. This can be done during a sample preparation step, for instance. The calibrant compound preferably has a well-defined and stable mass-to-charge ratio (m/z) that is different from any analyte compound.

In various embodiments, applying the algorithm may include a mass defect analysis of the mass spectrum. Preferably, mass defect analysis is carried out on signal peaks having monoisotopic mass in the mass spectrometry data. For that purpose, the mass spectrometry data, and in particular the mass spectra, may be subjected to a de-isotoping algorithm.

In various embodiments, a dataset may comprise mass defect data derived from the underlying mass-curated training spectrum. Preferably, the mass defect data may be given by pairs of (m, δ_{λ}(m)), the mass defect δ_{λ}(m) being calculated using the formula

$${δ}_{λ} = \frac{1}{λ} ( m - λ {m}_{N} ) = \frac{m}{λ} - ⌊ \frac{m}{λ} + 0.5 ⌋ ( Kendrick mass defect data ) ,$$

where [ . . . ] denotes the floor function, λ is a scaling factor, and m_{N} is the nearest nominal mass given by m_{N} arg min_{N∈N}|−λm_{N}|, and with m being replaced by mass-related values included in a mass spectrum.

In various embodiments, the mass defect data may be represented as a two-dimensional histogram Hover a mass-related axis and mass defect-related axis, accumulating ionic abundance values at a mass-related value m in a two-dimensional histogram bin containing a point (m, δ_{λ}(m)). Preferably, a dataset comprises {Hᵢ, Δᵢ} for i=1, . . . , N of histograms Hᵢ and deliberate mass-related scale modifications Δᵢ, and the training is executed by finding a parameter vector θ that minimizes the expression

$${min}_{θ} \frac{1}{N} {\sum }_{i = 1}^{N} {‖ {f}_{θ} ( {H}_{i} ) - {Δ}_{i} ‖}_{2}^{2} ,$$

where f_{θ} is a mapping of a histogram H to a mass-related scale modification Δ, the mapping being parameterized by the parameter vector θ.

In various embodiments, the mass-related axis may be divided into a number of K mass-related bins and the mass defect-related axis may be divided into a number of L mass defect-related bins, wherein K may be chosen from among the group including: 5, 10, 15, 20, 25, 30, 40, 50, and any other natural number greater than or equal to 5, and wherein L may be chosen from among the group including: 100, 150, 200, 250, 300, 350, 400, 500, and any other natural number greater than or equal to 100. A lower limit for the number of bins affords a solid data pool which allows robust and reliable statistical analysis.

In various embodiments, a mass-curated training spectrum may encompass one of a synthetic mass spectrum, which is generated in-silico, and a measured and calibrated mass spectrum. A synthetic mass spectrum may be a mass spectrum that is generated by a computer program or a mathematical model, rather than by a real mass spectrometer. It may be used to simulate an expected mass spectrum of a known or hypothetical compound. A synthetic mass spectrum may be advantageous because its generation may save time and resources, as it does not require the preparation and analysis of a real sample, or the operation and maintenance of a mass spectrometer, and it may serve as reference or standard for comparison, as it can represent the ideal or the optimal mass spectrum of a compound, without any noise, interference, or errors. In the context of the training, this may mean that the machine learning model can be trained to purely recognize and correct for deviations in mass or a mass-related parameter while being unaffected by other artifacts which may be present in a real measured mass spectrum. A measured and calibrated mass spectrum, on the other hand, may represent physical reality, including side effects and mass analyzer response beyond a theoretical scientific description, more accurately than can be reproduced in-silico, thus rendering a result more pertinent and closer to physical reality. It is contemplated that the body of training spectra used for the training, such as used for creating the multitude of datasets, may be composed of both synthetic mass spectra and measured and calibrated mass spectra.

In various embodiments, a deliberate mass-related scale modification may be taken from among the group including: linear or non-linear stretching, linear or non-linear squeezing, shifting. Preferably, a deliberate mass-related scale modification may be parameterized as Δ(m)=a×m^{q}+b, where Δ designates a mass shift, a and b are random real-valued parameters, m is a mass-related parameter, and q is a power coefficient, with q being preferably one of unity, which implicates a linear modification, and 0.5, which is an example of a non-linear modification.

In various embodiments, a number of mass-curated training spectra employed during the training may be taken from among the group including: 50, 100, 150, 200, 250, 300, 350, 400, 450, 500, and any other natural number larger than 50. Having a certain minimum number of mass-curated training spectra being contained in or for deriving the multitude of datasets may be beneficial and advantageous because the larger the number is, the better the generalization ability of the algorithm, which means that the performance of the algorithm on new and unseen data, and not just on the data the machine learning model was trained on, may be improved. A large number of datasets can moreover capture more diversity and variability in the data, and reduce the risk of overfitting or underfitting. Further, using a large number of mass-curated training spectra may increase accuracy and reliability of the algorithm, which means that the algorithm can produce correct and consistent results, and avoid errors or biases. This is because a large number of datasets can provide more evidence and support for the machine learning model to learn from, and reduce the impact of noise or outliers which the mass-curated training spectra may otherwise harbor.

In various embodiments, a number of deliberate mass-related scale modifications to which a mass-curated training spectrum is subjected may be taken from among the group including: 1, 500, 1000, 1500, 2000, 2500, 3000, 4000, 5000, and any other natural number larger than or equal to 1. It may be beneficial and preferred to subject each mass-curated training spectrum to different kinds of deliberate mass-related scale modifications, such as a variety of squeezing and/or stretching and/or shifting operations, in order to provide the training with multiple scenarios which have been found to potentially occur in real measurements.

In various embodiments, the mass spectrum, or a mass-curated training spectrum, may be taken during a measuring run of mass spectrometry imaging. Mass spectrometry imaging provides for a large amount of mass spectrometry data from a single source which may exhibit a high degree of molecular homogeneity, usually rendering them well suited for statistical evaluation purposes.

In various embodiments, the mass spectrum, or a mass-curated training spectrum, may contain measured ionic abundance values originating from a matrix substance suitable for matrix-assisted ionization, such as matrix-assisted laser desorption/ionization. MALDI affords ionization of large molecules, such as proteins, without any significant degree of fragmentation and renders an easily interpretable mass-related scale as the overwhelming majority of ions is singly charged.

In various embodiments, the mass spectrum, or a mass-curated training spectrum, may contain measured ionic abundance values originating from molecules taken from among the group including: peptides, proteins, lipids, polysaccharides, oligonucleotides, polymers. All elements from the preceding group comprise organic molecules, which means that they contain carbon atoms, usually bonded to hydrogen, oxygen, nitrogen, or other elements. Further, all elements from the preceding group comprise macromolecules, which means that they are large molecules made up of smaller subunits, or building blocks, called monomers. All elements from the preceding group comprise polymers, which means that they are chains of monomers linked by covalent bonds. The monomers can be the same or different, depending on the type of polymer. For example, peptides and proteins are made of amino acids, lipids are made of a head structure and one or more aliphatic hydrocarbon chains, polysaccharides are made of sugars, oligonucleotides are made of nucleotides. The bonds between the monomers may be of various types. For example, peptides and proteins have peptide bonds, lipids have ester bonds, polysaccharides have glycosidic bonds, oligonucleotides have phosphodiester bonds. Elements from the preceding group may have different structures and properties. For example, peptides and proteins can have complex three-dimensional shapes, lipids are mostly hydrophobic, polysaccharides can be linear or branched, oligonucleotides can form double helices. Generally, polymers can have different degrees of flexibility and rigidity.

In a further aspect, the disclosure relates to a method of generating a mass recalibration algorithm applicable to mass spectrometry data, comprising:—acquiring or providing a plurality of mass-curated training spectra; —applying one or more deliberate mass-related scale modifications to each mass-curated training spectrum from the plurality of mass-curated training spectra; —generating a plurality of datasets from the plurality of deliberately mass-related scale modified mass-curated training spectra by subjecting the plurality of deliberately mass-related scale modified mass-curated training spectra to mass defect analysis; —training for at least one of confirming and revising a mass-related scale of a mass spectrum by subjecting the plurality of datasets to machine learning with the aim of substantially undoing or substantially compensating for the one or more deliberate mass-related scale modifications; and—generating the mass recalibration algorithm using a result of the training.

Those of skill in the art will readily understand that any elements and any explanations disclosed previously in conjunction with the first aspect according to the disclosure may be compatible with, and applicable to the further aspect according to the disclosure so that they may be combined and jointly implemented as a skilled person sees fit.

### BRIEF DESCRIPTION OF THE DRAWINGS

The invention can be better understood by referring to the following figures. The elements in the figures are not necessarily to scale, emphasis instead being placed upon illustrating the principles of the invention (often schematically):

FIG. 1 shows Kendrick mass defect maps of an observed, pre-mass-calibrated spectrum, diagram a), and the corresponding recalibrated spectrum, diagram b). Solid lines indicate the estimated mass shift function, which is approximately zero after recalibration. Cross markers indicate expected masses of MALDI matrix cluster molecules from an a-priori model. The close-up diagrams c) and d) show how the discrepancies between observed and expected matrix peak positions are reduced by the recalibration.

FIG. 2 shows examples of randomly generated mass shift functions and the Kendrick mass defect plots of the corresponding training spectra. Diagrams a) and b) exhibit random mass shift proportional to mass, diagram a), and its square root, diagram b). Diagram c) illustrates a mass shift function obtained by adding a random offset to a real, observed mass shift function.

FIG. 3 presents a schematic overview of a neural network architecture in accordance with principles of the present disclosure.

FIG. 4 illustrates relative mass dispersion of the top 50 local maxima of a raw mean spectrum. The dashed horizontal lines represent the respective median standard deviations over all 31 MSI FFPE tissue sample datasets, which are the same data as used in the study by Tobias Boskamp et al.: Using the chemical noise background in MALDI mass spectrometry imaging for mass alignment and calibration. Analytical chemistry 2019, 92, 1301-1308.

FIG. 5 shows median mass errors of nine known MALDI-matrix peaks (vertical axis, m/z) for the pre-mass-calibrated data, as well as for data recalibrated using a method according to principles of the present disclosure.

### DETAILED DESCRIPTION

While the invention has been shown and described with reference to a number of different embodiments thereof, it will be recognized by those skilled in the art that various changes in form and detail may be made herein without departing from the scope of the invention as defined by the appended claims.

A method for mass recalibration of mass spectrometry data is described, in particular, in matrix assisted laser desorption/ionization (MALDI) mass spectrometry imaging (MSI) data.

In the following, an embodiment of a mass calibration method is described that encompasses (supervised) training of a multi-layered machine learning model, such as a neural network, to extract an observed spectrum's mass error from its so-called Kendrick mass defect map. Once the mass shift function, i.e., the mass error as a function of mass, is obtained, it is straight forward to recalibrate the spectrum or to adjust its mass axis or mass-related axis.

For training a machine learning model, such as a neural network, only a comparatively small number of mass-curated, i.e., accurately and precisely mass-calibrated, training spectra need be available. Such mass-curated training spectra may be generated in different ways, such as, for example, from an a-priori model describing the expected signal components of an actually measured spectrum. Alternatively, an existing mass-calibration method may be applied to only a small subset of measured mass spectra, making it feasible to utilize a computationally expensive algorithm for this purpose, or a method that for other reasons is not applicable to every spectrum.

### Mass Spectrometry Imaging (MSI)

As expounded before, in a typical mass spectrometry imaging experiment, a series of mass spectra is acquired from multiple locations (spots) uniformly distributed across a sample which extends in two dimensions. For each spot, molecules are extracted from the sample, ionized, and detected in a mass analyzer. The resulting mass spectrum comprises a sequence of mass-intensity pairs.

Note: The actual physical quantity measured by the mass detector of the mass analyzer is the mass-to-charge ratio, denoted as m/z. Thus, strictly speaking a spectrum comprises m/z- and intensity values. For simplicity, however, the term “mass” is used as a synonym for mass-to-charge ratio in the following and generally throughout the disclosure.

### Kendrick Mass Defect Map

The m/z value or molecular mass is given in Daltons (Da) as a multiple of the atomic mass unit (1 Da=1 amu). The mass in Dalton approximately corresponds to the total number of protons and neutrons comprising the atomic nuclei of the molecule. The difference between this integer nominal mass and the actual mass is called the mass defect (sometimes also termed mass excess). The mass defect of a molecule is the sum of the mass defects of the individual atoms, which are in turn different for each chemical element or isotope.

A similar concept is the so-called Kendrick mass defect, describing the mass defect of a molecular mass relative to a suitably chosen Kendrick scale (Edward Kendrick: A mass scale based on CH₂=14.0000 for high resolution mass spectrometry of organic compounds. Analytical Chemistry 1963, 35, 2146-2154). The Kendrick scale is chosen appropriately according to the considered molecular class and their corresponding typical repeating unit. In the classical case, for example, the Kendrick scale corresponds to the repeating unit CH₂. Alternative scales may be selected for the analysis of lipids, peptides, or glycans.

More specifically, the (centered) Kendrick mass defect to base A for a given molecular mass m is defined as

$${δ}_{λ} ( m ) = \frac{m}{λ} - floor ( \frac{m}{λ} + 0.5 ) .$$

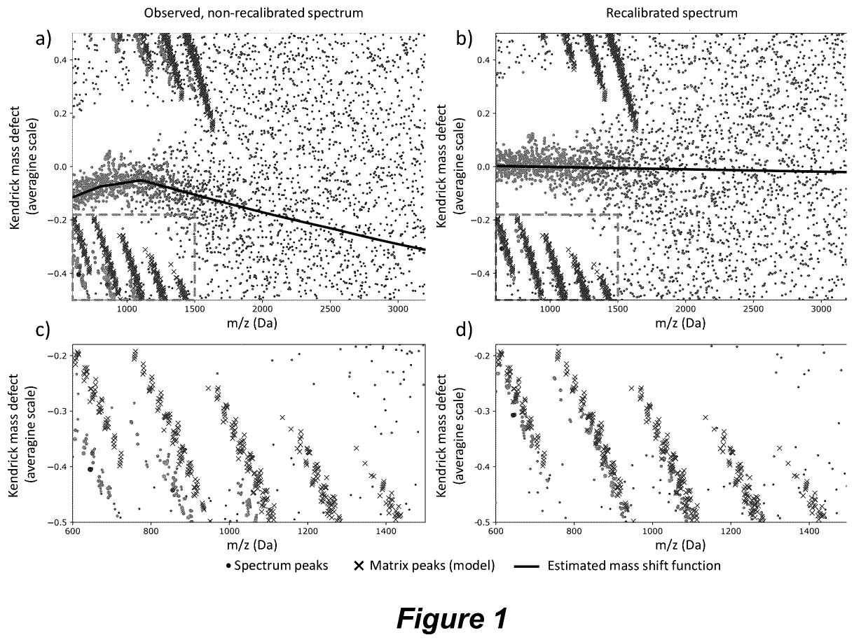

By this definition, the centered Kendrick mass defect is always in the range of [−0.5, 0.5]. Evaluating the Kendrick mass defect for all observed masses m in a spectrum defines the mass defect map (m, δ_{λ}(m)), which may be plotted in a diagram where the horizontal axis corresponds to the mass m (or m/z value), while the Kendrick mass defect δ_{λ}(m) is plotted on the vertical axis, confer FIG. 1. Note that the mass defect axis has a circular structure: Mass defects larger than 0.5 wrap around to the other side to a defect of −0.5 at a higher mass value.

The Kendrick mass defect map of a spectrum reveals specific patterns that depends on the type of analytes under consideration. Deviations of these patterns can be attributed to mass shifts, and thus the mass shift function can be estimated using the mass defect map. In FIG. 1, the mass defect map is shown for the example of a peptide measurement. For these analytes, the averagine peptide model can be employed, which is based on the observation that peptides are clustered around equidistant masses with a spacing of a little more than 1 Da (see Michael W. Senko et al.: Determination of monoisotopic masses and ion populations for large biomolecules from resolved isotopic distributions. Journal of the American Society for Mass Spectrometry 1995, 6, 229-233). The exact mass m of a peptide is approximately proportional to its nominal mass m_{N}, i.e., m≈λm_{N} with λ≈1.000495, and, as a consequence, δ_{λ}(m) is approximately zero for exact peptide masses. Thus, for observed spectra the deviation of the cluster formed by peptide masses from the line δ_{λ}(m)=0 in the Kendrick defect map directly corresponds to the effective mass shift function (see Tobias Boskamp et al.: Using the chemical noise background in MALDI mass spectrometry imaging for mass alignment and calibration. Analytical chemistry 2019, 92, 1301-1308). Other biopolymers may have other scaling parameters, such as λ=1.0035 for N-glycans.

The Kendrick mass defect map shown in FIG. 1 includes a further signal pattern that is not generated by peptide molecules but by MALDI matrix clusters. The matrix pattern has a different and more complex structure than the peptide pattern, reflecting the different chemical reactions and alterations in which MALDI matrix molecules may be involved. Likewise, other molecular classes, such as glycans, lipids, or polymers, each show their own characteristic patterns in the Kendrick mass defect map. In case a measured spectrum is affected by some effective mass shift, this mass shift is reflected by a distortion of the Kendrick mass defect map in a similar way as shown in FIG. 1 for the case of peptides. However, due to the higher complexity of these patterns, the effective mass shift is not as easily detectable from the Kendrick mass defect map.

A Kendrick mass defect map of a spectrum may be represented as a 2D histogram H over the mass and mass defect axes, accumulating the spectral intensities at mass m in the 2D histogram bin containing the point (m, δ_{λ}(m)). For this purpose, the mass and mass defect axes are subdivided into K and L bins, respectively, so that H can be represented as a matrix with K columns and L rows. A typical choice is to subdivide the mass axis or mass-related axis into K≈25 bins, and the mass defect axis into L=256 bins. This representation is robust in the presence of strong noise, as typically observed in single spectra, and at the same time allows to encode the Kendrick mass defect map by a fixed number of variables, allowing it to be used as the input to a neural network, for example.

### Description of a Preferred Embodiment

The proposed methods may encompass the following steps:
1. Generate a set of precisely mass-calibrated, i.e., mass-curated, training spectra with high mass accuracy.
2. Generate a set of training data by applying known mass shift functions to the mass-curated training spectra.
3. Train a machine learning model, such as a neural network, to map the Kendrick mass defect histogram for each mass-curated training spectrum to the corresponding known mass shift function.
4. Apply the trained algorithm, which implements a result of the machine learning, to the Kendrick mass defect histogram of a new pre-calibrated mass spectrum to obtain an estimate of the effective mass shift function for this measured mass spectrum.
5. Recalibrate the mass spectrum using the mass shift function estimated by the algorithm, which implements a result of the machine learning.

These steps are described in more detail, by way of example, in the following:

### Generate Mass-Curated Training Spectra

For training a machine learning model, such as a neural network, a relatively small number (typically not more than 150) of mass-curated training spectra is required. These mass-curated training spectra need to be similar to the actual mass spectra to be processed, i.e., the actually measured mass spectra that are later supposed to be recalibrated using the trained algorithm, which implements a result of the machine learning. Ideally, they comprise signal components coming from the same classes of molecules, including the analyte molecules under investigation as well as, as the case may be, the MALDI matrix molecules. Moreover, the type and level of the spectral noise in the mass-curated training spectra should be comparable to the noise in the actual mass spectra to be processed.

One option for obtaining such mass-curated training spectra is to employ an a-priori model of the spectral components and the noise to be expected in the actual mass spectra to be processed. For example, the above mentioned averagine model for peptides allows to statistically predict the exact masses expected from peptides in biological tissue, and thus to generate any number of random peptide masses. In addition, a chemical model of the MALDI matrix being used for ionization in the experiment may allow to predict the matrix cluster peaks observed in a real mass spectrum (see Bernd O. Keller et al.: Discerning matrix-cluster peaks in matrix-assisted laser desorption/ionization time-of-flight mass spectra of dilute peptide mixtures. Journal of the American Society for Mass Spectrometry 2000, 11, 88-93). Both models together, in a particularly favorable embodiment, may be used to randomly generate synthetic mass spectra that are similar to real, measured mass spectra of peptides while having a mass scale accuracy and precision close to perfection.

A further option for obtaining mass-curated training spectra is to apply an auxiliary mass recalibration method to real, measured and pre-mass-calibrated spectra. Since only a small set of mass-curated training spectra is required, it is feasible to use an auxiliary recalibration method that is limited to be applicable to only a small number of spectra. This limitation may be due to the high computational complexity of the auxiliary method. The above-mentioned a-priori model of spectral components, for example, may be employed in an auxiliary recalibration method to approximate the measured mass spectrum by suitably parameterized model components and their respective mass shifts. The resulting mass shift function may then be used to accurately and precisely mass-calibrate the training spectrum.

A different type of auxiliary recalibration method requires the detection of a-priori known calibrant signals in the measured mass spectrum. Depending on the choice of calibrants, such a method may be limited by the fact that the calibrants can be reliably detected in only a small part of the measured mass spectra. In the case where a specific calibrant mixture is applied to the sample, it may also be desirable to apply the mixture to only a small part of the sample, to avoid polluting the sample with calibrants that may have an adverse effect on the subsequent ionization and mass detection process. All these circumstances may make it cumbersome and time-consuming to apply the auxiliary recalibration method to the complete set of measured mass spectra, but still allow a sufficient number of training spectra to be accurately and precisely mass-calibrated.

Generate Training Data from the Mass-Curated Training Spectra

For training the machine learning model, in particular, a neural network, described in the next section, mass-curated training spectra with known mass shifts are required that are similar to the type of mass shifts observed in real, measured mass spectra. For a given mass-curated spectrum S having mass-intensity pairs (mₖ, sₖ) and a mass shift function Δ(m) describing the effective mass shift at mass m, the distorted spectrum S′ encompasses the mass-intensity pairs (mₖ+Δ(mₖ), sₖ). For generating the training data, each mass-curated training spectrum Sₙ generated in the previous step is combined with a large number (typically up to 2500) of mass shift functions Δ_{n,i}, yielding the same number of distorted training spectra S′_{n,i}. Here, the index n indicates the set of mass-curated training spectra, while index i represents the different mass shift functions. The full set of training data may encompass all the pairs (S′_{n,i}, Δ_{n,i}).

Two different ways may be used to generate the mass shift functions Δ_{n,i}: by random linear functions of m or a suitable power of m, and by randomly scaling real observed mass shift functions that are obtained together with the mass-curated training spectra using, by way of example, the auxiliary mass recalibration method, see above.

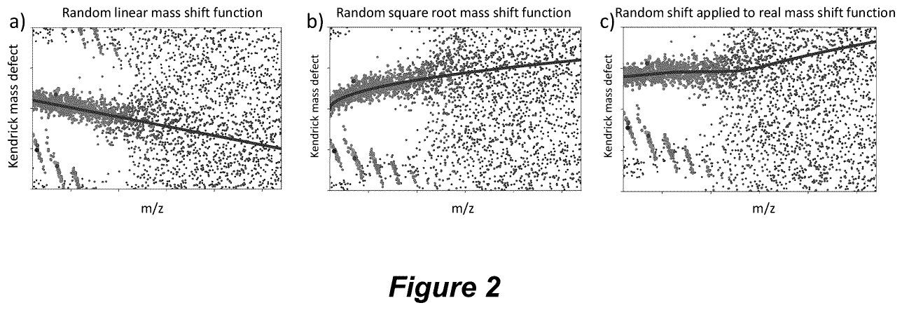

For the first option, purely synthetic mass shift functions are generated as Δ(m)=a×m^{q}+b, with real-valued parameters a and b randomly chosen from a suitable value range for each mass shift function. The exponent q is a fixed choice depending on the type of mass shift functions typically expected for the mass analyzer instrument being used. For time-of-flight (TOF) instruments, for example, it is known that observed mass shifts can be expected to be proportional to m or sqrt(m), hence q=1 and q=1/2 are appropriate, see FIG. 2, diagrams a) and b), respectively.

For the second option, a real, observed mass shift function Δ(m) is randomly transformed into a scaled function Δ′(m)=cΔ(am+b)+d, again with randomly chosen real-valued scaling parameters a, b, c, and d, see FIG. 2, diagram c). Note that this option requires that an auxiliary mass recalibration was used to extract the mass shift function from an observed mass spectrum. In order to obtain a set of mass-curated training spectra covering a wide range of potential mass shift functions, both options of generating mass shift functions may be combined when creating the training data.

### A Machine Learning Model, Such as a Neural Network, to Estimate the Effective Mass Shift of a Spectrum

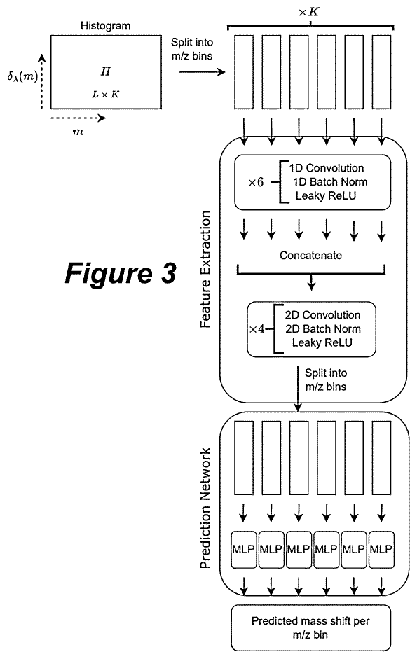

The core element of the proposed mass recalibration method may be embodied as a neural network that takes a spectrum's Kendrick mass defect histogram as input and computes the spectrum's effective mass shift function. The proposed architecture of this neural network is shown in FIG. 3. Since the input to this network, the mass defect histogram H, can be interpreted as an image, convolutional neural networks (CNN) may be used, which were successfully applied to a wide variety of imaging problems. More specifically, the neural network architecture may have an initial feature extraction block of several convolutional layers, followed by a fully connected prediction network.

### Feature Extraction Subnetwork

The feature extraction subnetwork may have two components. The first component may employ a series of K 1 D convolutional layers, each operating separately on a mass bin in the input histogram, i.e., on one column of the matrix H. For each column, a different set of 1 D convolution filters is applied, each integrating circular padding to account for the circular structure of the Kendrick mass defect. After each 1 D convolutional layer, 1 D batch normalization and a LeakyReLU activation function may be used. All in all, this component comprises six 1 D convolutional layers with batch normalization and activation functions.

In the second component, four 2D convolutional layers may be used, which allows information to be exchanged between mass bins. Here, 2D batch normalization and LeakyReLU activation functions are used after each 2D convolutional layer.

### Prediction Subnetwork

In the prediction subnetwork, first an initial 1 D convolution may be applied to reduce the number of channels to one. For each mass bin, then a multi-layer perceptron (MLP) is used to produce the final mass shift estimation for the bin. Each MLP is implemented as a fully connected layer with LeakyReLU activation functions. For the final output, a tangens hyperbolicus (tanh) activation function scaled by 0.5 may be used to ensure the output is always in the interval [−0.5, 0.5].

### Training the Neural Network

Training is performed in multiple iterations, making use of the training data generated beforehand (see below). In each iteration, a different set of mass-curated training spectra is used, together with the corresponding known mass shift functions. The Kendrick mass defect histograms for the mass-curated training spectra are fed into the neural network, and the network parameters are modified to minimize the difference between the neural network output and the expected mass shift functions. Training may use the Adam optimizer with a learning rate of 1e-4 and a batch size of 64.

Applying the Algorithm, which Implements a Result of the Neural Network Training, to Recalibrate a Mass Spectrum

In order to recalibrate a measured mass spectrum, the spectrum's Kendrick mass defect histogram is fed into the trained network. The output of the network is an estimate of the effective mass shift function for the measured mass spectrum. In order to recalibrate the spectrum, the negative mass shift is applied to the mass spectrum's mass axis or mass-related axis.

### Evaluation Results

To demonstrate the effectiveness of the new recalibration method, it is applied and evaluated on a set of 31 formalin fixed paraffin embedded (FFPE) tissue samples of peptide MALDI MSI measurements. Overall training took about 40 minutes per FFPE tissue sample data which divides into 3 minutes of generating training data and 37 minutes of machine learning proper. Recalibrating a mass spectrum from a sample spot took about 0.039 seconds using a graphics processing unit (GPU) of the type GeForce RTX 2080. Due to the absence of ground truth data containing perfectly mass-calibrated spectra, evaluating the precision of mass shift calibration methods poses a challenge. In the following, two distinct quality metrics are reported: the relative mass dispersion of high intensity peaks in the mean spectrum, as well as the absolute mass shift of selected known MALDI matrix peaks.

### Relative Mass Dispersion

For each of the 31 tissue sample datasets, the 50 highest intensity mean spectrum peaks are considered. For each of these top 50 peaks, the nearest peaks in all single spectra are computed. Those of the top 50 peaks that cannot be located in at least 10% of all spectra at a signal-to-noise ratio of at least 2.5:1 are discarded. Finally, the median mass dispersion across all remaining mean spectrum peaks is computed, where the mass dispersion for one mean spectrum peak is defined as the standard deviation of the respective peak locations in the single spectra, expressed in parts per million (ppm) relative to the peak's m/z value, such as its centroid.

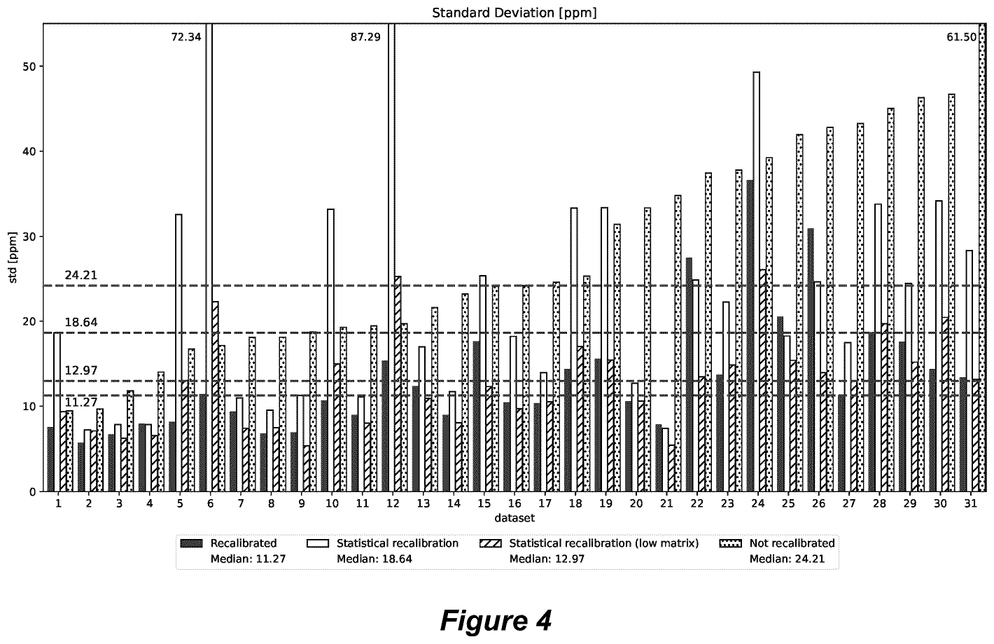

FIG. 4 shows the results of this evaluation for all tissue sample datasets, comparing the new recalibration method to the original, pre-mass-calibrated data, as well as to the data recalibrated using the statistical recalibration method of Tobias Boskamp et al. herein cited previously. Since the latter was explicitly designed to be applicable only to spectra with a sufficiently low level of MALDI matrix signal peaks, additional results were added where this method was only applied to such low matrix spectra.

The new method according to principles of the present disclosure achieves the lowest median mass dispersion of 11.27 ppm, which is better than the mass dispersion of 12.96 ppm obtained for the statistical recalibration evaluated on low matrix spectra. When the statistical recalibration is evaluated on all spectra, increasing the computing time significantly, the mass dispersion increases to 18.64 ppm, making the performance gap even wider. Thus, in contrast to the statistical recalibration, the new method according to principles of the present disclosure is applicable to mass spectra containing strong MALDI matrix signals, increasing the robustness of the recalibration.

### Absolute Mass Error

For quantifying the absolute mass error, the absolute mass shift of nine selected known MALDI matrix peaks is considered (vertical axis, m/z). For this purpose, the aforementioned combinatorial model for matrix molecules is used, allowing to assess the mass error as the distance of a measured peak to the closest theoretical matrix peak. For each matrix peak and each tissue sample dataset, the median mass error across all spectra is computed.

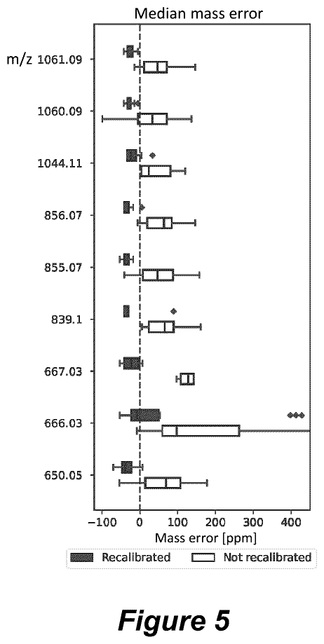

The results are shown in FIG. 5, representing the median mass errors for all tissue sample datasets separately for each of the nine matrix peaks. On average across all nine matrix peaks, the new method according to principles of the present disclosure yields a median mass error of −28.70 ppm, compared to 63.88 ppm observed in the original, pre-mass-calibrated data. This shows the quality gain, the execution of methods according to principles of the present disclosure provide.

The invention has been shown and described above with reference to a number of different embodiments thereof. It will be understood, however, by a person skilled in the art that various aspects or details of the invention may be changed, or various aspects or details of different embodiments may be arbitrarily combined, if practicable, without departing from the scope of the invention. For example, the methods according to the disclosure have been described above with reference to mass spectrometry data which have only one or at least only one dominating signal component, namely peptides. Skilled practitioners will acknowledge, however, that principles of the present disclosure may be generalized to scenarios where not only one or only one dominating signal component occurs but two or even more. Approaches how to deal with this more complex data structure are disclosed by the applicant, for example, in US 2020/0328069 A1 which is incorporated herein by reference in its entirety. Generally, the foregoing description is for the purpose of illustration only, and not for the purpose of limiting the invention which is defined solely by the appended claims, including any equivalent implementations, as the case may be.

1. A method of mass spectrometry, comprising:
acquiring or providing a mass spectrum which encompasses a plurality of measured ionic abundance values, each measured ionic abundance value from the plurality of measured ionic abundance values being associated with a value or value range on a first mass-related scale;
applying an algorithm on the mass spectrum which includes a mapping of ionic abundance values to a second mass-related scale, the mapping encompassing at least one of (i) a confirming where the second mass-related scale substantially coincides with the first mass-related scale, and (ii) a revising where the second mass-related scale does not substantially coincide with the first mass-related scale; and
processing the mass spectrum to have a mass-related scale which is at least one of confirmed and revised;
wherein the algorithm implements a result of training on a multitude of datasets using machine learning, wherein each dataset from the multitude of datasets contains and/or derives from a mass-curated training spectrum which is subjected to one or more deliberate mass-related scale modifications, and wherein the training aims at providing for the mapping to substantially undo or substantially compensate for the one or more deliberate mass-related scale modifications.

2. The method of claim 1, wherein the acquiring of a mass spectrum is carried out using an analyzer working according to a principle taken from among the group including: time-of-flight analyzer, ion cyclotron resonance analyzer, analyzer of the Kingdon type, such as the Orbitrap®.

3. The method of claim 1, wherein the mass-related scale comprises one of a mass scale, m, and a mass to charge ratio scale, m/z.

4. The method of claim 1, wherein the machine learning includes a method taken from among the group including: multi-layered machine learning, supervised machine learning, deep learning, neural network, such as convolutional neural network.

5. The method of claim 4, wherein the neural network has an architecture which comprises an initial block including a plurality of convolutional layers, followed by a second block including a plurality of fully connected layers.

6. The method of claim 1, wherein the first mass-related scale is pre-mass-calibrated using raw mass spectrometry data and applying thereon a method taken from among the group including: internal lockmass calibrants, external lockmass calibrants, statistical evaluation of molecular content.

7. The method of claim 1, wherein applying the algorithm includes a mass defect analysis of the mass spectrum.

8. The method of claim 1, wherein a dataset comprises mass defect data derived from the underlying mass-curated training spectrum.

9. The method of claim 8, wherein the mass defect data is given by pairs of (m, δ_{λ}(m)), the mass defect δ_{λ}(m) being calculated using the formula
$${δ}_{λ} = \frac{1}{λ} ( m - λ {m}_{N} ) = \frac{m}{λ} - ⌊ \frac{m}{λ} + 0.5 ⌋ ,$$
where [ . . . ] denotes the floor function, A is a scaling factor, and m_{N} is the nearest nominal mass given by m_{N}=arg min_{N∈N}|m−λm_{N}|, and with m being replaced by mass-related values included in a mass spectrum.

10. The method of claim 8, wherein the mass defect data are represented as a two-dimensional histogram Hover a mass-related axis and mass defect-related axis, accumulating ionic abundance values at a mass-related value m in a two-dimensional histogram bin containing the pair (m, δ_{λ}m)).

11. The method of claim 10, wherein a dataset comprises {Hᵢ, Δᵢ} for i=1, . . . , N of histograms Hᵢ and deliberate mass-related scale modifications Δᵢ, and the training is executed by finding a parameter vector θ that minimizes the expression
$${min}_{θ} \frac{1}{N} {\sum }_{i = 1}^{N} {‖ {f}_{θ} ( {H}_{i} ) - {Δ}_{i} ‖}_{2}^{2} ,$$
where f_{θ} is a mapping of a histogram H to a mass-related scale modification Δ, the mapping being parameterized by the parameter vector θ.

12. The method of claim 10, wherein the mass-related axis is divided into a number of K mass-related bins and the mass defect-related axis is divided into a number of L mass defect-related bins, wherein K is chosen from among the group including: 5, 10, 15, 20, 25, 30, 40, 50, and any other natural number greater than or equal to 5, and wherein L is chosen from among the group including: 100, 150, 200, 250, 300, 350, 400, 500, and any other natural number greater than or equal to 100.

13. The method of claim 1, wherein a mass-curated training spectrum encompasses one of a synthetic mass spectrum, which is generated in-silico, and a measured and calibrated mass spectrum.

14. The method of claim 1, wherein a deliberate mass-related scale modification is taken from among the group including: linear or non-linear stretching, linear or non-linear squeezing, shifting.

15. The method of claim 1, wherein a deliberate mass-related scale modification is parameterized as Δ(m)=a×m^{q}+b, where Δ designates a mass shift, a and b are random real-valued parameters, m is a mass-related parameter, and q is a power coefficient, with q being preferably one of unity and 0.5.

16. The method of claim 1, wherein a number of mass-curated training spectra employed during the training is taken from among the group including: 50, 100, 150, 200, 250, 300, 350, 400, 450, 500, and any other natural number larger than 50.

17. The method of claim 1, wherein a number of deliberate mass-related scale modifications to which a mass-curated training spectrum is subjected is taken from among the group including: 1, 500, 1000, 1500, 2000, 2500, 3000, 4000, 5000, and any other natural number larger than or equal to 1.

18. The method of claim 1, wherein the mass spectrum, or a mass-curated training spectrum, is taken during a measuring run of mass spectrometry imaging.

19. The method of claim 1, wherein the mass spectrum, or a mass-curated training spectrum, contains measured ionic abundance values originating from a matrix substance suitable for matrix-assisted ionization, such as matrix-assisted laser desorption/ionization.

20. The method of claim 1, wherein the mass spectrum, or a mass-curated training spectrum, contains measured ionic abundance values originating from molecules taken from among the group including: peptides, proteins, lipids, polysaccharides, oligonucleotides, polymers.

21. A method of generating a mass recalibration algorithm applicable to mass spectrometry data, comprising:
acquiring or providing a plurality of mass-curated training spectra;
applying one or more deliberate mass-related scale modifications to each mass-curated training spectrum from the plurality of mass-curated training spectra;
generating a plurality of datasets from the plurality of deliberately mass-related scale modified mass-curated training spectra by subjecting the plurality of deliberately mass-related scale modified mass-curated training spectra to mass defect analysis;
training for at least one of confirming and revising a mass-related scale of a mass spectrum by subjecting the plurality of datasets to machine learning with the aim of substantially undoing or substantially compensating for the one or more deliberate mass-related scale modifications; and
generating the mass recalibration algorithm using a result of the training.
